(19) United States
(12) Patent Application Publication
(10) Pub. No.: US 2011/0059357 A1
(43) Pub. Date: Mar. 10, 2011

(54) NONAQUEOUS ELECTROLYTE BATTERY

(75) Inventors: Izaya Okae, Fukushima (JP); Shinya Wakita, Fukushima (JP); Masayuki Ihara, Fukushima (JP)

(73) Assignee: SONY CORPORATION, Tokyo (JP)

(21) Appl. No.: 12/875,316

(22) Filed: Sep. 3, 2010

(30) Foreign Application Priority Data
Sep. 10, 2009 (JP) P2009-209045

(51) Int. Cl. H01M 10/02

(52) U.S. Cl. 429/188

(57) ABSTRACT

A nonaqueous electrolyte battery includes: a positive electrode containing a positive electrode active material composed of a lithium complex oxide; a negative electrode; and a nonaqueous electrolyte containing a nonaqueous solvent, an electrolyte salt and at least one additive selected from the group consisting of a sulfone compound (1) represented by the following general formula (1) and a sulfone compound (2) represented by the following general formula (2)

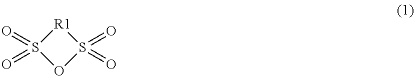

wherein R1 represents CₘH₂ₘ₋ₙXₙ; X represents a halogen; m represents an integer of 2 or more and not more than 4; and n represents an integer of 0 or more and not more than 2m, and

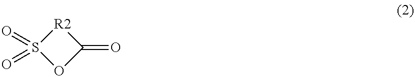

wherein R2 represents CⱼH₂ⱼ₋ₖXₖ; X represents a halogen; j represents an integer of 2 or more and not more than 4; and k represents an integer of 0 or more and not more than 2j.

### CROSS REFERENCES TO RELATED APPLICATIONS

The present application claims priority Japanese Priority Patent Application JP 2009-209045 filed in the Japan Patent Office on Sep. 10, 2009, the entire contents of which is hereby incorporated by reference.

### BACKGROUND

The present application relates to a nonaqueous electrolyte secondary battery. In particular, the present application relates to a nonaqueous electrolyte battery capable of suppressing the deterioration of a battery capacity following floating or a charge and discharge cycle.

Owing to the remarkable development of a portable electronic technology in recent years, electronic appliances such as mobile phones and laptop personal computers have started to be recognized as a basic technology supporting a high-level information society. Also, research and development on high functionalization of such an electronic appliance are energetically advanced, and the consumed electric power of such an electronic appliance increases steadily in proportion thereto. On the contrary, such an electronic appliance is to be driven over a long period of time, and realization of a high energy density of a secondary battery as a drive power source has been inevitably desired. Also, in view of consideration of the environment, the prolongation of a cycle life has been desired.

From the viewpoints of occupied volume and mass of a battery to be built in an electronic appliance, it is desirable that the energy density of the battery is high as far as possible. At present, in view of the fact that a lithium ion secondary battery has an excellent energy density, the lithium ion secondary battery is now built in almost all of appliances.

As a positive electrode active material which is used for a positive electrode of a lithium ion secondary battery, there has hitherto been most widely used a lithium cobalt complex oxide. In a lithium manganese complex oxide having high safety against the overcharged state in case of emergency or the like and a lithium nickel complex oxide having a higher capacity, an expansion of utilization as a positive electrode active material is being expected. In such a complex oxide, a technology for increasing a comprehensive balance as a positive electrode active material against, for example, a countermeasure for storage deterioration or an enhancement of safety in the case where it is used for a lithium ion secondary battery is being studied.

For example, JP-A-2001-338684 discloses a technology for solid-solving aluminum (Al), manganese (Mg), cobalt (Co), nickel (Ni) and the like in a lithium manganese complex oxide to form a positive electrode active material. Also, JP-A-2001-266876 discloses a technology for solid-solving cobalt and aluminum in a lithium manganese complex oxide to form a positive electrode active material. Furthermore, JP-A-2001-266876 discloses a technology for solid-solving other metals than lithium and manganese in a lithium manganese complex oxide to form a positive electrode active material.

Furthermore, it is proposed to add other materials to a positive electrode active material. For example, JP-A-2002-270181 discloses that by mixing a phthalimide compound in, for example, a positive electrode, a dissolution reaction of a positive electrode active material is suppressed. Also, JP-A-2002-270181 discloses that by mixing a phthalimide compound in a negative electrode, deposition of the dissolved positive electrode active material on the negative electrode surface can be suppressed.

### SUMMARY

However, when an electronic appliance provided with a battery pack with a built-in secondary battery is allowed to stand in, for example, a state where it is connected to a battery charger, etc., the secondary battery within the battery pack is exposed in a charged state (floated state). In the secondary battery exposed in the floated state, there may be the case where the battery capacity is deteriorated due to the use environment of an electronic appliance. This is caused due to the fact that at the time of charge, the positive electrode is laid in an oxidized environment, and a transition metal contained in the positive electrode active material, such as manganese and nickel, elutes, thereby bringing an increase of the interface resistance. At the same time, this is also caused due to the fact that a crystal structure of the positive electrode active material changes, thereby bringing a lowering of the capacity. Furthermore, an elevation of the surrounding temperature following the drive of the electronic appliance becomes a factor of accelerating the deterioration.

However, as improvement measures, by solid-solving transition metals of a different kind from each other as in the above-cited JP-A-2001-338684 and JP-A-2001-266876, there give rise to certain effects. However, it may be hardly said that such effects are sufficient.

Also, in JP-A-2002-270181, a phthalimide powder is, for example, uniformly attached onto the surface of the positive electrode active material. In this respect, the phthalimide powder is a granular powder of several tens μm, and therefore, even when further pulverized, it is difficult to attach and cover the phthalimide powder thinly and uniformly on the surface of the positive electrode active material. When it is intended to realize uniform surface covering, it is necessary to attach the phthalimide compound in a larger amount than the specified amount onto the surface of the positive electrode active material. In that case, an amount of a material which does not contribute to the charge and discharge increases, resulting in a lowering of the battery capacity.

Thus, it is desirable to provide a nonaqueous electrolyte battery with excellent floating characteristic and cycle characteristic.

According to an embodiment, there is provided a nonaqueous electrolyte battery including:

a positive electrode containing a positive electrode active material composed of a lithium complex oxide;

a negative electrode; and

a nonaqueous electrolyte containing a nonaqueous solvent, an electrolyte salt and at least one additive selected from the group consisting of a sulfone compound (1) represented by the following general formula (1) and a sulfone compound (2) represented by the following general formula (2).

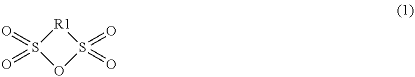

In the foregoing general formula (1), R1 represents CₘH₂ₘ₋ₙXₙ; X represents a halogen; m represents an integer of 2 or more and not more than 4; and n represents an integer of 0 or more and not more than 2m.

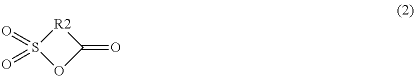

In the foregoing general formula (2), R2 represents CⱼH₂ⱼ₋ₖXₖ; X represents a halogen; j represents an integer of 2 or more and not more than 4; and k represents an integer of 0 or more and not more than 2j.

The sulfone compound (1) represented by the foregoing general formula (1) is preferably a sulfone compound (3) represented by the following formula (3).

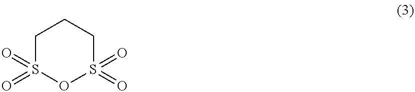

Also, it is preferable that an amount of the additive is from 0.03% by mass or more and not more than 5.0% by mass relative to the nonaqueous electrolyte.

According to the embodiment, a coating film containing a sulfur compound is formed on the surface of a positive electrode active material, whereby elution of the positive electrode active material can be suppressed even in oxidizing activation of the positive electrode at the time of charge.

According to the embodiment, it is possible to suppress oxidizing activation on the surface of a positive electrode active material at the time of charge and to obtain a high capacity retention rate.

Additional features and advantages are described herein, and will be apparent from the following Detailed Description and the figures.

### BRIEF DESCRIPTION OF THE FIGURES

FIG. 1 is a sectional view expressing a configuration example of a nonaqueous electrolyte battery according to an embodiment.

FIG. 2 is a sectional view enlargedly expressing a part of a wound electrode body shown in FIG. 1.

### DETAILED DESCRIPTION

An embodiment according to the present application is hereunder described. The embodiment described below is a specific example of the present application; and though various technically preferred limitations are given, in the following description, it should not be construed that the scope of the present application is limited to this embodiment unless otherwise specifically indicating that the present application is limited thereto. The description is made in the following order.

### 1. First Embodiment

### An Example of Nonaqueous Electrolyte Secondary Battery Having a Cylinder Type

1. First Embodiment

(1-1) Re: Additive to be Added to a Nonaqueous Electrolytic Solution According to the Embodiment

First of all, the sulfone compound to be added to an electrolytic solution, which is a characteristic feature of the embodiment according to the present application, is described. A solvent, an electrolyte salt and the like constituting a nonaqueous electrolytic solution are described later.

In the nonaqueous electrolyte battery according to the embodiment, the nonaqueous electrolytic solution contains, as an additive, at least one member selected from the group consisting of a sulfone compound (1) represented by the following general formula (1) and a sulfone compound (2) represented by the following general formula (2).

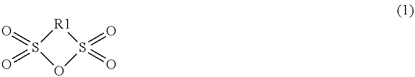

In the foregoing general formula (1), R1 represents CₘH₂ₘ₋ₙXₙ; X represents a halogen; m represents an integer of 2 or more and not more than 4; and n represents an integer of 0 or more and not more than 2m.

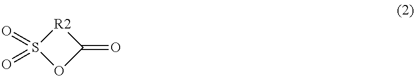

In the foregoing general formula (2), R2 represents CⱼH₂ⱼ₋ₖXₖ; X represents a halogen; j represents an integer of 2 or more and not more than 4; and k represents an integer of 0 or more and not more than 2j.

As expressed by the foregoing chemical formulae, each of the sulfone compound (1) and the sulfone compound (2) is a cyclic sulfonic anhydride.

Specifically, it is more preferable to use an additive having a structure of a sulfone compound (3) represented by the following formula (3).

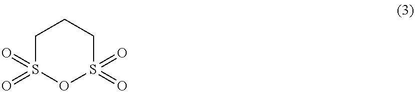

By adding such an additive to the nonaqueous electrolytic solution, a coating film containing a sulfur compound is formed on the surface of a positive electrode active material, whereby elution of the positive electrode active material can be suppressed even in oxidizing activation of the positive electrode at the time of charge. It may be considered that this coating film takes a lithium salt structure of ring-opened sulfonic acid.

Such an additive exhibits the effect upon being added in the nonaqueous electrolytic solution, and its amount is preferably in the range of 0.03% by mass or more and not more than 5.0% by mass. When the amount of the additive is less than the foregoing range, the coating film is not sufficiently formed on the surface of the positive electrode active material so that the effect for suppressing elution of a transition metal becomes small. On the other hand, when the amount of the additive is more than the foregoing range, the coating film is formed too thick on the surface of the positive electrode active material so that the resistance on the coating film increases.

Furthermore, it is more preferable that the amount of the additive is in the range of 0.1% by mass or more and not more than 5.0% by mass. By choosing the foregoing range, it is possible to enhance characteristics of the nonaqueous electrolyte battery more conspicuously.

Here, as other specific compounds of the sulfone compound (1), compounds having the following structures can be exemplified.

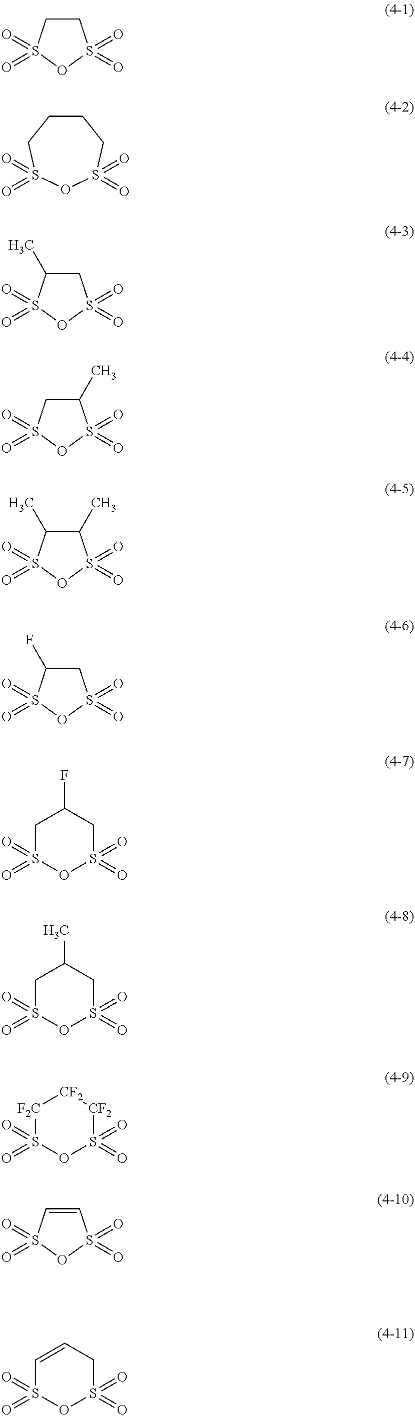

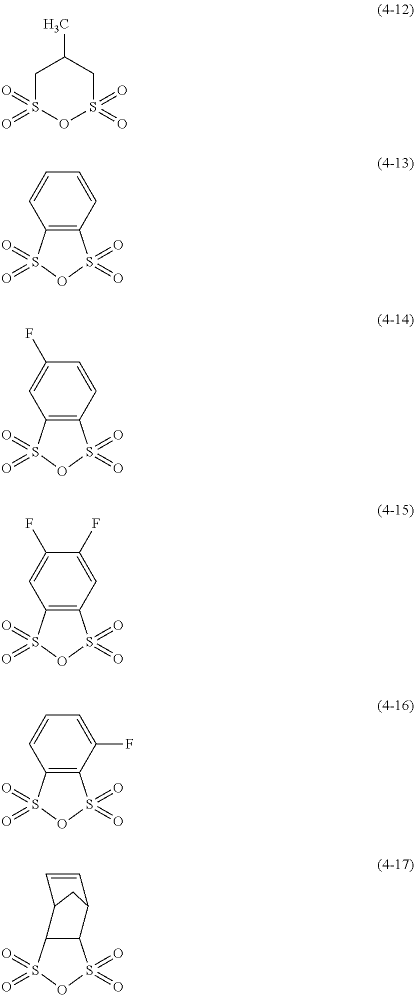

Also, as other specific compounds of the sulfone compound (2), compounds having the following structures can be exemplified.

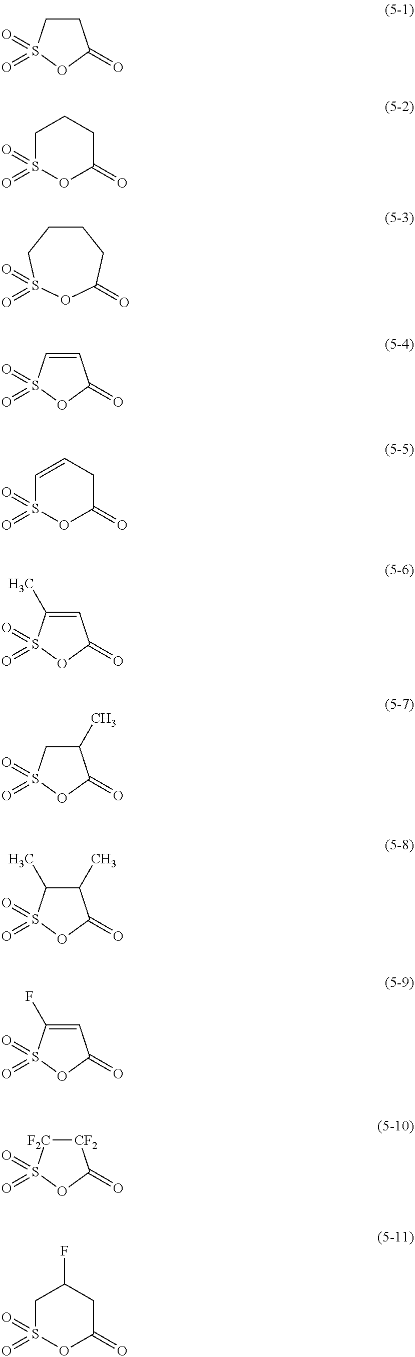

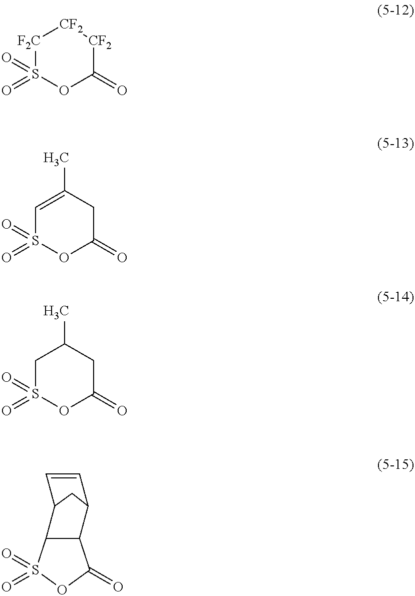

(1-2) Configuration of Nonaqueous Electrolyte Secondary Battery

An embodiment according to the present application is hereunder described by reference to the accompanying drawings.

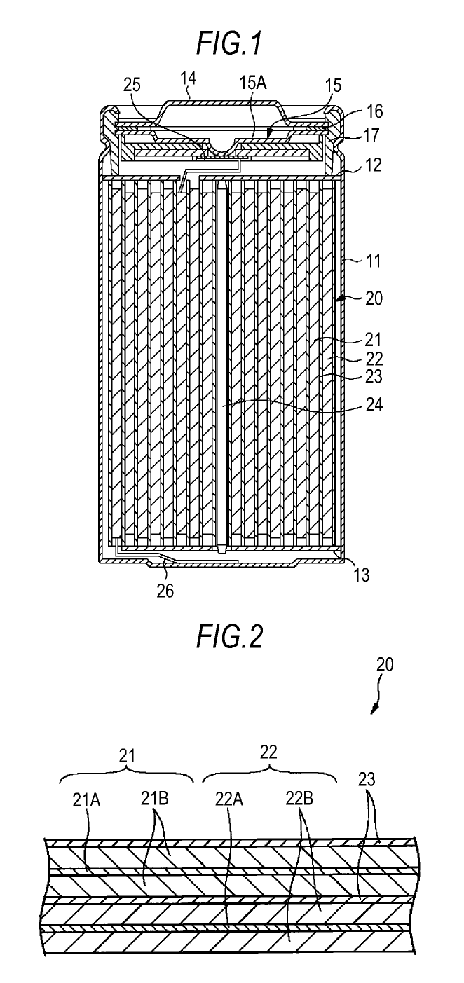

FIG. 1 shows a sectional structure of the secondary battery according to an embodiment. This battery is, for example, a lithium ion secondary battery.

As shown in FIG. 1, this secondary battery is of a so-called cylinder type and has a wound electrode body 20 having a strip-shaped positive electrode 21 and a strip-shaped negative electrode 22 wound via a separator 23 in the inside of a substantially hollow columnar battery can 11. The battery can 11 is constituted of, for example, iron (Fe) plated with nickel (Ni), and one end thereof is closed, with the other end being opened. In the inside of the battery can 11, a pair of insulating plates 12 and 13 is respectively disposed vertical to the winding peripheral face so as to interpose the wound electrode body 20 therebetween.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed. The battery lid 14 is constituted of, for example, the same material as that in the battery can 11.

The safety valve mechanism 15 is electrically connected to the battery lid 14 via the positive temperature coefficient device 16. In this safety valve mechanism 15, when the internal pressure of the battery reaches a fixed value or more due to an internal short circuit or heating from the outside or the like, a disc plate 15A is reversed, whereby electrical connection between the battery lid 14 and the wound electrode body 20 is disconnected. When the temperature rises, the positive temperature coefficient device 16 controls the current by an increase of the resistance value, thereby preventing abnormal heat generation to be caused due to a large current. The gasket 17 is constituted of, for example, an insulating material, and asphalt is coated on the surface thereof.

For example, the wound electrode body 20 is wound on the center of a center pin 24. In the wound electrode body 20, a positive electrode lead 25 made of aluminum (Al) or the like is connected to the positive electrode 21; and a negative electrode lead 26 made of nickel (Ni) or the like is connected to the negative electrode 22. The positive electrode lead 25 is electrically connected to the battery lid 14 by means of welding with the safety valve mechanism 15; and the negative electrode lead 26 is electrically connected to the battery can 11 by means of welding.

FIG. 2 shows enlargedly a part of the wound electrode body 20 shown in FIG. 1.

### Positive Electrode

The positive electrode 21 includes, for example, a positive electrode collector 21A and a positive electrode active material layer 21B provided on the both surface of the positive electrode collector 21A. The positive electrode 21 may be configured to include a region where the positive electrode active material layer 21B exists on only one surface of the positive electrode collector 21A. The positive electrode collector 21A is constituted, for example, of a metal foil such as an aluminum (Al) foil.

The positive electrode active material layer 21B contains, for example, a positive electrode active material, a conductive agent such as fibrous carbon and carbon black and a binder such as polyvinylidene fluoride (PVdF). As the positive electrode active material, a known lithium complex oxide can be used. For example, a lithium complex oxide having a spinel structure, in which at least one member selected from the group consisting of Ni, Co and Mn is solid-solved and displaced as a transition metal, is preferable. Such a lithium complex oxide is preferable because a high battery capacity can be obtained.

As such a positive electrode active material, for example, a lithium manganese oxide can be used. As the lithium manganese oxide, one having a composition represented by the following chemical formula (1) is preferable.

Li₁₊ₓMn₂₋yM1yO4 Chemical formula (1)

In the foregoing chemical formula (1), 0≦x≦0.15; 0≦y≦0.3; and M1 represents at least one member of elements selected from the group consisting of nickel (Ni), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W).

Also, in addition to the foregoing lithium manganese oxide, a lithium nickel oxide may be used. As the lithium nickel oxide, one having a composition represented by the following chemical formula (2) is preferable.

LiₐNi₁₋bM2bO2 Chemical formula (2)

In the foregoing chemical formula (2), 0.05 a 1.2; 0 b 0.5; and M2 represents at least one member of elements selected from the group consisting of iron (Fe), cobalt (Co), manganese (Mn), copper (Cu), zinc (Zn), aluminum (Al), boron (B), gallium (Ga) and magnesium (Mg).

Above all, by choosing at least one member of aluminum and magnesium as M1, the battery characteristics can be more conspicuously improved in the embodiment according to the present application.

It is desirable that such a positive electrode active material has a specific surface area, as measured by the BET (Brunauer-Emmett-Teller) method using a nitrogen (N₂) gas, falling within the range of from 0.05 m²/g or more and not more than 2.0 m²/g, and preferably from 0.2 m²/g or more and not more than 0.7 m²/g. This is because by regulating the positive electrode active material so as to fall within the foregoing range, a more effective film can be formed.

The conductive agent is not particularly limited so far as it is able to impart conductivity upon being mixed in an appropriate amount to the positive electrode active material, and for example, carbon materials such as carbon black and graphite are useful. As the binder, a known binder which is usually used for a positive electrode mixture of a battery of this kind can be used, and a fluorine based resin such as polyvinyl fluoride (PVF), polyvinylidene fluoride (PVdF) and polytetrafluoroethylene (PTFE) is preferably used.

Negative Electrode

The negative electrode 22 has, for example, a negative electrode collector 22A and a negative electrode active material layer 22B provided on the both surfaces of the negative electrode collector 22A. The negative electrode 22 may be configured to include a region where the negative electrode active material layer 22B exists on only one surface of the negative electrode collector 22A. The negative electrode collector 22A is constituted of, for example, a metal foil such as a copper (Cu) foil.

The negative electrode active material layer 22B contains, for example, a negative electrode active material and may contain other materials which do not contribute to the charge, such as a conductive agent, a binder and a viscosity modifier as the need arises. Examples of the conductive agent include a graphite fiber, a metal fiber and a metal powder. Examples of the binder include fluorine based polymer compounds such as polyvinylidene fluoride (PVdF); and synthetic rubbers such as a styrene-butadiene rubber (SBR) and an ethylene-propylene-diene rubber (EPDR).

The negative electrode active material is constituted to include one or two or more kinds of negative electrode materials capable of electrochemically intercalating and deintercalating lithium (Li) at a potential of not more than 2.0 V relative to the lithium metal.

Examples of the negative electrode material capable of intercalating and deintercalating lithium (Li) include carbon materials, metal compounds, oxides, sulfides, lithium nitrides such as LiN₃, a lithium metal, metals capable of forming an alloy together with lithium and polymer materials.

Examples of the carbon material include hardly graphitized carbon, easily graphitized carbon, graphite, pyrolytic carbons, cokes, vitreous carbons, organic polymer compound baked materials, carbon fibers and active carbon. Of these, examples of the cokes include pitch coke, needle coke and petroleum coke. The organic polymer compound baked material as referred to herein is a material obtained through carbonization by baking a polymer material such as a phenol resin and a furan resin at an appropriate temperature, and a part thereof is classified into hardly graphitized carbon or easily graphitized carbon. Also, examples of the polymer material include polyacetylene and polypyrrole.

Of such negative electrode materials capable of intercalating and deintercalating lithium (Li), those having a charge and discharge potential relatively close to that of the lithium metal are preferable. This is because the lower the charge and discharge potential of the negative electrode 22, the easier the achievement of a high energy density of the battery. Above all, carbon materials are preferable because a change in the crystal structure to be generated at the time of charge and discharge is very small, a high charge and discharge capacity is obtainable, and a satisfactory cycle characteristic is obtainable. Graphite is especially preferable because its electrochemical equivalent is large, and a high energy density is obtainable. Also, hardly graphitized carbon is preferable because an excellent cycle characteristic is obtainable.

Here, in the case of using hardly graphitized carbon, one which has a spacing of the (002) plane of 0.37 nm or more and a true density of less than 1.70 g/cm³ and which does not show an exothermic peak at 700° C. or higher in a differential thermal analysis (DTA) in air is preferable.

Also, examples of the negative electrode material capable of intercalating and deintercalating lithium (Li) include a simple substance of a lithium metal; and a simple substance, an alloy or a compound of a metal element or a semi-metal element capable of forming an alloy together with lithium (Li). These substances are preferable because a high energy density is obtainable. In particular, a joint use of such a substance with a carbon material is more preferable because not only a high energy density is obtainable, but an excellent cycle characteristic is obtainable. In this specification, the “alloy” as referred to herein includes, in addition to alloys composed of two or more kinds of metal elements, alloys composed of at least one member of a metal element and at least one member of a semi-metal element. Examples of its texture include a solid solution, a eutectic (eutectic mixture), an intermetallic compound and one in which two or more kinds thereof coexist.

Examples of such a metal element or semi-metal element include tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) and hafnium (Hf). Examples of such an alloy or compound include those represented by a chemical formula: Ma_{f}Mb_{g}Liₕ or a chemical: MaₛMcₜMdᵤ. In these chemical formulae, Ma represents at least one member of metal elements and semi-metal elements capable of forming an alloy together with lithium; Mb represents at least one member of metal elements and semi-metal elements other than lithium and Ma; Mc represents at least one member of non-metal elements; and Md represents at least one member of metal elements and semi-metal elements other than Ma. Also, the values of f, g, h, s, t and u are values satisfied with the relationships of f>0, g≧0, h≧0, s>0, t>0 and u≧0, respectively.

Above all, a simple substance, an alloy or a compound of a metal element or a semi-metal element belonging to the Group 4B of the short form of the periodic table is preferable; and silicon (Si) or tin (Sn) or an alloy or a compound thereof is especially preferable. These materials may be crystalline or amorphous.

Furthermore, examples of the negative electrode material capable of intercalating and deintercalating lithium include oxides, sulfides and other metal compounds inclusive of lithium nitrides such as LiN₃. Examples of the oxide include MnO₂, V₂O₅, V₆O₁₃, NiS and MoS. Besides, examples of oxides having a relatively base potential and capable of intercalating and deintercalating lithium include iron oxide, ruthenium oxide, molybdenum oxide, tungsten oxide, titanium oxide and tin oxide. Examples of the sulfide include NiS and MoS.

Separator

The separator 23 partitions the positive electrode 21 and the negative electrode 22 from each other and allows a lithium ion to pass therethrough while preventing a short circuit of the current to be caused due to the contact of the between the positive electrode 21 and the negative electrode 22. The separator 23 is constituted of, for example, a porous film made of a synthetic resin such as polytetrafluoroethylene (PTFE), polypropylene (PP) and polyethylene (PE); or a porous film made of a ceramic. The separator 23 may have a structure in which two or more kinds of the foregoing porous films are laminated.

Above all, a polyolefin-made porous film is preferable because it is excellent in an effect for preventing a short circuit from occurring and is able to contrive to enhance the safety of the battery due to a shutdown effect. In particular, polyethylene is preferable as a material constituting the separator 23 because not only it is able to obtain a shutdown effect at a temperature falling within the range of 100° C. or higher and not higher than 160° C., but it is excellent in electrochemical stability. Also, polypropylene is preferable. Besides, a resin may be used upon being copolymerized or blended with polyethylene or polypropylene so far as it is a resin provided with chemical stability.

Nonaqueous Electrolytic Solution

The nonaqueous electrolytic solution is one containing a liquid solvent, for example, a nonaqueous solvent such as organic solvents, and an electrolyte salt dissolved in this nonaqueous solvent. In the embodiment according to the present application, the additive composed of a sulfone compound is added. The sulfone compound is described in detail in the foregoing (1-1), and therefore, its description is omitted herein.

It is preferable that the nonaqueous solvent contains at least one member of cyclic carbonates, for example, ethylene carbonate (EC), propylene carbonate (PC), etc. This is because the cycle characteristic can be enhanced. In particular, what the nonaqueous solvent contains a mixture of ethylene carbonate (EC) and propylene carbonate (PC) is preferable because the cycle characteristic can be more enhanced.

Also, it is preferable that the nonaqueous solvent contains at least one member of chain carbonates such as diethyl carbonate (DEC), dimethyl carbonate (DMC), ethyl methyl carbonate (EMC) and methyl propyl carbonate (MPC). This is because the cycle characteristic can be more enhanced.

The nonaqueous solvent may further contain one or two or more kinds of butylene carbonate, γ-butyrolactone, γ-valerolactone, compounds obtained by substituting a part or all of the hydrogen groups of such a compound with a fluorine group, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropyronitrile, N,N-dimethylformamide, N-methylpyrrolidinone, N-methyloxazolidinone, N,N-dimethylimidazolidinone, nitromethane, nitroethane, sulfolane, dimethyl sulfoxide and trimethyl phosphate.

There may be the case where by using a compound obtained by substituting a part or all of the hydrogen atoms of a substance included in the foregoing nonaqueous solvent group with a fluorine atom, the reversibility of an electrode reaction is enhanced depending upon the electrode to be combined. In consequence, it is also possible to properly use such a substance.

As the electrolyte salt, a lithium salt can be used. Examples of the lithium salt include inorganic lithium salts such as lithium hexafluorophosphate (LiPF₆), lithium tetrafluoroborate (LiBF₄), lithium hexafluoroarsenate (LiAsF₆), lithium hexafluoroantimonate (LiSbF₆), lithium perchlorate (LiClO₄) and lithium tetrachloroaluminate (LiAlCl₄); and perfluoroalkanesulfonic acid derivatives such as lithium trifluoromethanesulfonate (LiCF₃SO₃), lithium bis(trifluoromethanesulfonyl)imide (LiN(CF₃SO₂)₂), lithium bis(pentafluoroethanesulfonyl)imide (LiN(C₂F₅SO₂)₂) and lithium tris(trifluoromethanesulfonyl)methide (LiC(CF₃SO₂)₃). These materials can be used singly or in combinations of two or more kinds thereof. Above all, lithium hexafluorophosphate (LiPF₆) is preferable because not only high ionic conductivity can be obtained, but the cycle characteristic can be enhanced.

On the other hand, a solid electrolyte may be used in place of the nonaqueous electrolytic solution. Any of an inorganic solid electrolyte or a polymer solid electrolyte can be used as the solid electrolyte so far as it is a material having lithium ionic conductivity. Examples of the inorganic solid electrolyte include lithium nitride (Li3N) and lithium iodide (LiI). The polymer solid electrolyte is composed of an electrolyte salt and a polymer compound capable of dissolving the electrolyte salt therein. As the polymer compound, for example, an ether based polymer such as poly(ethylene oxide) and a crosslinked material thereof, a poly(methacrylate) ester based compound, an acrylate based compound, or the like can be used singly or upon being copolymerized or mixed in a molecule.

Furthermore, a gel electrolyte may be used. As a matrix polymer of the gel electrolyte, various polymers are useful so far as they are able to absorb the foregoing nonaqueous electrolytic solution and gelate it. For example, fluorine based polymers such as poly(vinylidene fluoride) and poly(vinylidene fluoride-co-hexafluoropropylene); ether based polymers such as poly(ethylene oxide) and a crosslinked material thereof; poly(acrylonitrile); and the like can be used. In particular, it is desirable to use a fluorine based polymer from the standpoint of oxidation-reduction stability. The ionic conductivity is imparted by containing the electrolyte salt.

(1-3) Preparation Method of Nonaqueous Electrolyte Secondary Battery

This secondary battery can be, for example, manufactured in the manner as described below. First of all, an example of the manufacturing method of a positive electrode active material according to the embodiment is described.

Manufacturing Method of Positive Electrode

For example, a positive electrode active material, a conductive agent and a binder are mixed to prepare a positive electrode mixture; and this positive electrode mixture is dispersed in a solvent such as N-methylpyrrolidone to form a positive electrode mixture slurry. Subsequently, this positive electrode mixture slurry is coated on the positive electrode collector 21A, and after drying the solvent, the resultant is subjected to compression molding by a roll press or the like, thereby forming the positive electrode active material 21B. There is thus prepared the positive electrode 21.

Manufacturing Method of Negative Electrode

Also, for example, a negative electrode active material and a binder are mixed to prepare a negative electrode mixture, and this negative electrode mixture is dispersed in a solvent such as N-methylpyrrolidone to form a negative electrode mixture slurry. Subsequently, this negative electrode mixture slurry is coated on the negative electrode collector 22A, and after drying the solvent, the resultant is subjected to compression molding by a roll press or the like, thereby forming the negative electrode active material 22B. There is thus prepared the negative electrode 22.

Assembling of Nonaqueous Electrolyte Secondary Battery

Subsequently, the positive electrode lead 25 is installed in the positive electrode collector 21A by means of welding, etc., and the negative electrode lead 26 is also installed in the negative electrode collector 22A by means of welding, etc. Thereafter, the positive electrode 21 and the negative electrode 22 are wound via the separator 23; a tip of the positive electrode lead 25 is welded to the safety valve mechanism 15; a tip of the negative electrode lead 26 is then welded to the battery can 11; and the wound positive electrode 21 and the negative electrode 22 are interposed between the pair of the insulating plates 12 and 13 and then housed in the inside of the battery can 11.

After housing the positive electrode 21 and the negative electrode 22 in the inside of the battery can 11, an electrolytic solution having a sulfone compound added thereto is injected into the inside of the battery can 11, thereby impregnating the separator 23 therewith. Thereafter, the battery lid 14, the safety valve mechanism 15 and the positive temperature coefficient element 16 are fixed to the open end of the battery can 11 via the gasket 17 by caulking. There can be thus manufactured the secondary battery shown in FIG. 1.

### EXAMPLES

### Example 1

In Example 1, secondary batteries of a cylinder type having a wound structure shown in FIGS. 1 and 2 were prepared by changing a compound to be added to an electrolytic solution and evaluated.

### Example 1-1

### Preparation of Positive Electrode

A complex oxide (LiMn_{1.9}Al_{0.1}O₄) obtained by solid-solving aluminum (Al) in lithium manganate and having an accumulated 50% particle size (median particle size), as measured by the laser diffraction method, of 13 μm was used as a positive electrode active material.

3.0% by mass of polyvinylidene fluorine (PVdF) as a binder was well dispersed in N-methyl-2-pyrrolidone as a solvent, thereby preparing a mixed solution. Subsequently, this mixed solution was mixed with 94% by mass of the foregoing positive electrode active material and 3% by mass of ketjen black as a conductive agent to prepare a positive electrode mixture, thereby preparing a positive electrode mixture slurry.

Subsequently, this positive electrode mixture slurry was uniformly coated on the both surfaces of a positive electrode collector made of a strip-shaped aluminum foil having a thickness of 20 μm After drying the coated positive electrode mixture slurry, the resultant was compression molded by a roll press to form a positive electrode active material layer, thereby preparing a positive electrode. On that occasion, a thickness of one surface of the positive electrode active material layer was set up at 80 μm Finally, a positive electrode terminal made of aluminum was installed in one end of the positive electrode collector.

Preparation of Negative Electrode

A granular graphite powder made of a mesophase small sphere having a lattice spacing d002 in the C-axis direction in the X-ray diffraction of 0.336 nm and a median particle size of 15.6 μm was used as a negative electrode active material. 95% by mass of this negative electrode active material and 5.0% by mass of polyvinylidene fluoride as a binder were mixed, and the mixture was dispersed in N-methyl-2-pyrrolidone as a solvent to prepare a negative electrode mixture slurry.

Subsequently, this negative electrode mixture slurry was uniformly coated on the both surfaces of a negative electrode collector made of a strip-shaped copper foil having a thickness of 15 μm. After drying the coated negative electrode mixture slurry, the resultant was compression molded by a roll press to form a negative electrode active material layer, thereby preparing a negative electrode. On that occasion, a thickness of one surface of the negative electrode active material layer was set up at 70 μm Finally, a negative electrode terminal made of nickel was installed in three areas in one end of the negative electrode collector.

Preparation of Electrolytic Solution

A solution prepared by dissolving lithium hexafluorophosphate (LiPO₄) as an electrolyte salt in a proportion of 1.28 moles/kg in a mixed solvent of ethylene carbonate (EC), dimethyl carbonate (DMC) and propylene carbonate (PC) in a volume ratio of 20/70/10 was used as the electrolytic solution. On that occasion, the foregoing sulfone compound (3) was added as an additive in an amount of 1.0% by mass relative to the whole of the electrolytic solution.

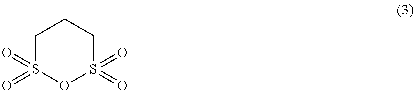

Assembling of Secondary Battery of a Cylinder Type

The thus prepared positive electrode and negative electrode were laminated via a separator made of a microporous polyethylene stretched film having a thickness of 18 μm in the order of the negative electrode, the separator, the positive electrode and the separator, thereby preparing a laminate. The resulting laminate was wound many times, thereby preparing a wound electrode body. Subsequently, the wound electrode body was interposed between a pair of insulating plates; not only the negative electrode terminal was welded with a battery can, but the positive electrode terminal was welded with a safety valve mechanism; and the wound electrode body was then housed in the inside of the battery can. Finally, the electrolytic solution was injected into the inside of the battery can, and a battery lid was caulked with the battery can via a gasket, thereby preparing a secondary battery of a cylinder type.

### Example 1-2

A secondary battery of a cylinder type was prepared in the same manner as in Example 1-1, except that the foregoing sulfone compound (4-1) was used in place of the sulfone compound (3).

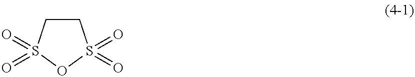

### Example 1-3

A secondary battery of a cylinder type was prepared in the same manner as in Example 1-1, except that the foregoing sulfone compound (5-1) was used in place of the sulfone compound (3).

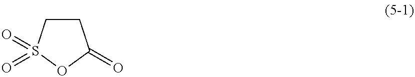

### Comparative Example 1-1

A secondary battery of a cylinder type was prepared in the same manner as in Example 1-1, except that the sulfone compound (3) was not added.

Evaluation of secondary battery: Measurement of capacity retention rate

Each of the thus prepared secondary batteries of a cylinder type of Examples 1-1 to 1-3 and Comparative Example 1-1 was subjected to a floating test at 45° C. and examined with respect to a capacity retention rate after a lapse of 2,000 hours after full charge.

First of all, the secondary battery of a cylinder type was placed in a thermostat set up at 45° C. and charged at a constant current of 1 C until a battery voltage reached 4.2 V. Thereafter, the charge manner was switched to constant-voltage charge at 4.2 V, and the battery was charged until the total charge amount reached 2.5 hours, to achieve full charge, thereby making it in a floated state. The battery after a lapse of one hour after the full charge was discharged at a constant current of 1 C; the discharge was completed at the point of time when the battery voltage reached 3.0 V; and a discharge capacity after a lapse of one hour was measured. Furthermore, with respect to the battery after a lapse of 2,000 hours after the full charge, a discharge capacity after a lapse of 2,000 hours was measured in the same method. A capacity retention rate after a lapse of 2,000 hours was determined according to an expression of {(battery capacity after a lapse of 2,000 hours)/(battery capacity after a lapse of one hour)}×100.

Results of the evaluation are shown in the following Table 1.

TABLE 1

| | | Electrolytic solution | | | | |
|---|---|---|---|---|---|---|
| | Positive electrode | | | | Amount | Capacity |
| | active material | | Mixing | Kind of | [% by | retention rate |
| | Complex oxide | Solvent | ratio | additive | mass] | [%] |
| Example 1-1 | LiMn_{1.9}Al_{0.1}O₄ | Ethylene | 20 | Compound | 1.0 | 96 |
| | | carbonate | | (3) | | |
| Example 1-2 | | Dimethyl | 70 | Compound | 1.0 | 92 |
| | | carbonate | | (4-1) | | |
| Example 1-3 | | Propylene | 10 | Compound | 1.0 | 85 |
| | | carbonate | | (5-1) | | |
| Comparative | | | | — | 0 | 23 |
| Example 1-1 | | | | | | |

As shown in Table 1, in the secondary battery of a cylinder type of Comparative Example 1-1 in which the sulfone compound was not added, the capacity retention rate was very low as 23%. On the other hand, in Examples 1-1 to 1-3 in which the sulfone compound was added, the capacity retention rate was conspicuously enhanced as compared with that in Comparative Example 1-1. Above all, in the case of using the sulfone compound (3), an especially high effect was obtained.

### Example 2

In Example 2, secondary batteries were evaluated by using the sulfone compound (3) and changing its amount.

### Example 2-1

A secondary battery of a cylinder type was prepared in the same manner as in Example 1-1, except that the amount of the sulfone compound (3) was set up at 0.03% by mass.

### Example 2-2

A secondary battery of a cylinder type was prepared in the same manner as in Example 1-1, except that the amount of the sulfone compound (3) was set up at 0.1% by mass.

### Example 2-3

A secondary battery of a cylinder type was prepared in the same manner as in Example 1-1, except that the amount of the sulfone compound (3) was set up at 0.5% by mass.

### Example 2-4

A secondary battery of a cylinder type was prepared in the same manner as in Example 1-1, except that the amount of the sulfone compound (3) was set up at 1.0% by mass.

### Example 2-5

A secondary battery of a cylinder type was prepared in the same manner as in Example 1-1, except that the amount of the sulfone compound (3) was set up at 3.0% by mass.

### Example 2-6

A secondary battery of a cylinder type was prepared in the same manner as in Example 1-1, except that the amount of the sulfone compound (3) was set up at 5.0% by mass.

### Example 2-7

A secondary battery of a cylinder type was prepared in the same manner as in Example 1-1, except that the amount of the sulfone compound (3) was set up at 7.0% by mass.

### Comparative Example 2-1

A secondary battery of a cylinder type was prepared in the same manner as in Example 1-1, except that similar to Comparative Example 1-1, the sulfone compound (3) was not added.

Evaluation of Secondary Battery: Measurement of Capacity Retention Rate

A capacity retention rate of each of Examples 2-1 to 2-7 and Comparative Example 2-1 was measured in the same method as in Example 1.

Results of the measurement are shown in the following Table 2.

TABLE 2

| | | Electrolytic solution | | | | |
|---|---|---|---|---|---|---|
| | Positive electrode | | | | Amount | Capacity |
| | active material | | Mixing | Kind of | [% by | retention rate |
| | Complex oxide | Solvent | ratio | additive | mass] | [%] |
| Example 2-1 | LiMn_{1.9}Al_{0.1}O₄ | Ethylene | 20 | Compound | 0.03 | 63 |
| | | carbonate | | (3) | | |
| Example 2-2 | | Dimethyl | 70 | Compound | 0.1 | 79 |
| | | carbonate | | (3) | | |
| Example 2-3 | | Propylene | 10 | Compound | 0.5 | 82 |
| | | carbonate | | (3) | | |
| Example 2-4 | | | | Compound | 1.0 | 96 |
| | | | | (3) | | |
| Example 2-5 | | | | Compound | 3.0 | 84 |
| | | | | (3) | | |
| Example 2-6 | | | | Compound | 5.0 | 73 |
| | | | | (3) | | |
| Example 2-7 | | | | Compound | 7.0 | 48 |
| | | | | (3) | | |
| Comparative | | | | — | 0 | 23 |
| Example 2-1 | | | | | | |

As shown in Table 2, in Examples 2-1 to 2-7 in which the sulfone compound was added, the capacity retention rate was enhanced as compared with that in Comparative Example 2-1 in which the sulfone compound was not added. Above all, there could be obtained the results revealing that when the amount of the sulfone compound is in the range of 0.03% by mass or more and not more than 5.0% by mass, the capacity retention rate is high as 60% or more, and in particular, when the amount of the sulfone compound is in the range of 0.1% by mass or more and not more than 5.0% by mass, the capacity retention rate is especially high as 70% or more.

When the sulfone compound is added in the electrolytic solution, a coating film is formed on the positive electrode or the surface of the positive electrode active material. In the case where the amount of the sulfone compound is too small, the coating film is not sufficiently formed on the surface of the positive electrode active material so that the effect for suppressing elution of a transition metal is small. On the other hand, in the case where the amount of the sulfone compound is too large, the coating film is formed too thick on the surface of the positive electrode active material so that the resistance on the coating film increases. For that reason, by regulating the amount of the sulfone compound, a more conspicuous effect can be obtained.

### Example 3

In Example 3, the effect to be brought by the addition of the sulfone compound was confirmed by changing the positive electrode active material.

### Example 3-1

A secondary battery of a cylinder type was prepared in the same manner as in Example 1-1, except that lithium manganate (LiMn_{1.}9Al0_{.1}O₄) having aluminum solid-solved therein was used as the positive electrode active material and that the amount of the sulfone compound (3) was set up at 1.0% by mass.

### Example 3-2

A mixture of lithium manganate (LiMn_{1.9}Al_{0.1}O₄) having aluminum solid-solved therein and lithium nickelate (LiNi_{0.8}CO_{0.15}Al_{0.05}O₄) having cobalt (Co) and aluminum (Al) solid-solved therein and having a median particle size of 15 μm was used as the positive electrode active material. At that time, a mixture of LiMn_{1.9}Al_{0.1}O₄ and LiNi_{0.8}CO_{0.15}Al_{0.05}O₄ in a mass ratio of 70/30 was used. A secondary battery of a cylinder type was prepared in the same manner as in Example 1-1, except for this.

### Example 3-3

A secondary battery of a cylinder type was prepared in the same manner as in Example 1-1, except that a mixture of LiMn_{1.9}Al_{0.1}O₄ and LiNi_{0.8}CO_{0.15}Al_{0.05}O₄ in a mass ratio of 30/70 was used as the positive electrode active material. As LiNiCoAlO₄, the same material as in Example 3-2 was used.

### Comparative Example 3-1

A secondary battery of a cylinder type was prepared in the same manner as in Example 1-1, except that similar to Comparative Example 1-1, the sulfone compound (3) was not added.

### Comparative Example 3-2

A secondary battery of a cylinder type was prepared in the same manner as in Example 1-1, except that a mixture of LiMn1.9Al0.1O4 and LiNi0.8Co0.15Al0.05O4 in a mass ratio of 70/30 was used as the positive electrode active material and that the sulfone compound (3) was not added. As LiNiCoAlO₄, the same material as in Example 3-2 was used.

### Comparative Example 3-3

A secondary battery of a cylinder type was prepared in the same manner as in Example 1-1, except that a mixture of LiMn_{1.9}Al_{0.1}O₄ and LiNi_{0.8}CO_{0.15}Al_{0.05}O₄ in a mass ratio of 30/70 was used as the positive electrode active material and that the sulfone compound (3) was not added. As LiNiCoAlO₄, the same material as in Example 3-2 was used.

Evaluation of Secondary Battery: Measurement of Capacity Retention Rate

A capacity retention rate of each of Examples 3-1 to 3-3 and Comparative Examples 3-1 to 3-3 was measured in the same method as in Example 1.

Results of the measurement are shown in the following Table 3.

TABLE 3

| | | | Electrolytic solution | | | | |
|---|---|---|---|---|---|---|---|
| | Positive electrode active material | | | | | Amount | Capacity |
| | | Mixing | | Mixing | Kind of | [% by | retention rate |
| | Complex oxide | ratio | Solvent | ratio | additive | mass] | [%] |
| Example 3-1 | LiMn_{1.9}Al_{0.1}O₄ | — | Ethylene | 20 | Compound | 1.0 | 96 |
| | | | carbonate | | (3) | | |
| Example 3-2 | LiMn_{1.9}Al_{0.1}O₄ | 70 | Dimethyl | 70 | Compound | 1.0 | 93 |
| | LiNi_{0.8}Co_{0.15}Al_{0.05}O₂ | 30 | carbonate | | (3) | | |
| Example 3-3 | LiMn_{1.9}Al_{0.1}O₄ | 30 | Propylene | 10 | Compound | 1.0 | 95 |
| | LiNi_{0.8}Co_{0.15}Al_{0.05}O₂ | 70 | carbonate | | (3) | | |
| Comparative | LiMn_{1.9}Al_{0.1}O₄ | — | | | — | 0 | 23 |
| Example 3-1 | | | | | | | |
| Comparative | LiMn_{1.9}Al_{0.1}O₄ | 70 | | | — | 0 | 28 |
| Example 3-2 | LiNi_{0.8}Co_{0.15}Al_{0.05}O₂ | 30 | | | | | |
| Comparative | LiMn_{1.9}Al_{0.1}O₄ | 30 | | | — | 0 | 35 |
| Example 3-3 | LiNi_{0.8}Co_{0.15}Al_{0.05}O₂ | 70 | | | | | |

As shown in Table 3, by adding the sulfone compound, the effect for enhancing the capacity retention rate was obtained regardless of the composition and mixing ratio of the positive electrode active material.

### Example 4

In Example 4, secondary batteries were evaluated by changing the composition of the solvent of the electrolytic solution.

### Example 4-1

A secondary battery of a cylinder type was prepared in the same manner as in Example 1-1, except that the solvent composition of the electrolytic solution was changed to a composition composed of ethylene carbonate (EC), dimethyl carbonate (DMC) and propylene carbonate (PC) in a proportion of 20/70/10.

### Example 4-2

A secondary battery of a cylinder type was prepared in the same manner as in Example 1-1, except that the solvent composition of the electrolytic solution was changed to a composition composed of ethylene carbonate (EC), dimethyl carbonate (DMC) and propylene carbonate (PC) in a proportion of 10/80/10.

### Example 4-3

A secondary battery of a cylinder type was prepared in the same manner as in Example 1-1, except that the solvent composition of the electrolytic solution was changed to a composition composed of ethylene carbonate (EC), dimethyl carbonate (DMC), propylene carbonate (PC) and fluorinated ethylene carbonate in a proportion of 10/70/10/10.

### Comparative Example 4-1

A secondary battery of a cylinder type was prepared in the same manner as in Example 1-1, except that similar to Comparative Example 1-1, the sulfone compound (3) was not added.

### Comparative Example 4-2

A secondary battery of a cylinder type was prepared in the same manner as in Example 1-1, except that the solvent composition of the electrolytic solution was changed to a composition composed of ethylene carbonate (EC), dimethyl carbonate (DMC) and propylene carbonate (PC) in a proportion of 10/80/10 and that the sulfone compound (3) was not added.

### Comparative Example 4-3

A secondary battery of a cylinder type was prepared in the same manner as in Example 1-1, except that the solvent composition of the electrolytic solution was changed to a composition composed of ethylene carbonate (EC), dimethyl carbonate (DMC), propylene carbonate (PC) and fluorinated ethylene carbonate in a proportion of 10/70/10/10 and that the sulfone compound (3) was not added.

Evaluation of Secondary Battery: Measurement of Capacity Retention Rate

A capacity retention rate of each of Examples 4-1 to 4-3 and Comparative Examples 4-1 to 4-3 was measured in the same method as in Example 1.

Results of the measurement are shown in the following Table 4.

TABLE 4

| | | Electrolytic solution | | | | |
|---|---|---|---|---|---|---|
| | Positive electrode | | | | Amount | Capacity |
| | active material | | Mixing | Kind of | [% by | retention rate |
| | Complex oxide | Solvent | ratio | additive | mass] | [%] |
| Example 4-1 | LiMn_{1.9}Al_{0.1}O₄ | Ethylene carbonate | 20 | Compound | 1.0 | 96 |
| | | Dimethyl carbonate | 70 | (3) | | |
| Example 4-2 | | Propylene carbonate | 10 | Compound | 1.0 | 94 |
| | | | | (3) | | |
| Example 4-3 | | Ethylene carbonate | 10 | Compound | 1.0 | 96 |
| | | Dimethyl carbonate | 70 | (3) | | |
| | | Propylene carbonate | 10 | | | |
| | | Fluorinated ethylene | 10 | | | |
| | | carbonate | | | | |
| Comparative | | Ethylene carbonate | 20 | — | 0 | 23 |
| Example 4-1 | | Dimethyl carbonate | 70 | | | |
| Comparative | | Propylene carbonate | 10 | — | 0 | 22 |
| Example 4-2 | | | | | | |
| Comparative | | Ethylene carbonate | 10 | — | 0 | 38 |
| Example 4-3 | | Dimethyl carbonate | 70 | | | |
| | | Propylene carbonate | 10 | | | |
| | | Fluorinated ethylene | 10 | | | |
| | | carbonate | | | | |

As shown in Table 4, by adding the sulfone compound, the effect for enhancing the capacity retention rate was obtained regardless of the composition of the solvent of the electrolytic solution.

### Example 5

In Example 5, secondary batteries were evaluated by changing the element to be solid-solved in lithium manganate.

### Example 5-1

A secondary battery of a cylinder type was prepared in the same manner as in Example 1-1, except that lithium manganate (LiMn_{1.9}Al_{0.1}O₄) having aluminum (Al) solid-solved therein was used as the positive electrode active material.

### Example 5-2

A secondary battery of a cylinder type was prepared in the same manner as in Example 1-1, except that lithium manganate (LiMn_{1.9}Mg_{0.1}O₄) having magnesium (Mg) solid-solved therein was used as the positive electrode active material.

### Example 5-3

A secondary battery of a cylinder type was prepared in the same manner as in Example 1-1, except that lithium manganate (LiMn_{1.9}Al_{0.05}Mg_{0.05}O₄) having aluminum and magnesium solid-solved therein was used as the positive electrode active material.

### Example 5-4

A secondary battery of a cylinder type was prepared in the same manner as in Example 1-1, except that lithium manganate (LiMn₂O₄) was used as the positive electrode active material.

### Example 5-5

A secondary battery of a cylinder type was prepared in the same manner as in Example 1-1, except that lithium manganate (LiMn_{1.9}Cr_{0.1}O₄) having chromium (Cr) solid-solved therein was used as the positive electrode active material.

### Example 5-6

A secondary battery of a cylinder type was prepared in the same manner as in Example 1-1, except that lithium manganate (LiMn_{1.9}Fe_{0.1}O₄) having iron (Fe) solid-solved therein was used as the positive electrode active material.

### Example 5-7

A secondary battery of a cylinder type was prepared in the same manner as in Example 1-1, except that lithium manganate (LiMn_{1.9}Ni_{0.1}O₄) having nickel (Ni) solid-solved therein was used as the positive electrode active material.

### Example 5-8

A secondary battery of a cylinder type was prepared in the same manner as in Example 1-1, except that lithium manganate (LiMn_{1.9}Cu_{0.1}O₄) having copper (Cu) solid-solved therein was used as the positive electrode active material.

Evaluation of Secondary Battery: Measurement of Capacity Retention Rate

A capacity retention rate of each of Examples 5-1 to 5-8 was measured in the same method as in Example 1.

Results of the measurement are shown in the following Table 5.

TABLE 5

| | | Electrolytic solution | | | | |
|---|---|---|---|---|---|---|
| | Positive electrode active | | | | Amount | Capacity |
| | material | | Mixing | Kind of | [% by | retention rate |
| | Complex oxide | Solvent | ratio | additive | mass] | [%] |
| Example 5-1 | LiMn_{1.9}Al_{0.1}O₄ | Ethylene carbonate | 20 | Compound | 0.1 | 96 |
| | | Dimethyl carbonate | 70 | (3) | | |
| Example 5-2 | LiMn_{1.9}Mg_{0.1}O₄ | Propylene carbonate | 10 | Compound | 0.1 | 91 |
| | | | | (3) | | |
| Example 5-3 | LiMn_{1.9}Al_{0.05}Mg_{0.05}O₄ | | | Compound | 0.1 | 93 |
| | | | | (3) | | |
| Example 5-4 | LiMn₂O₄ | | | Compound | 0.1 | 71 |
| | | | | (3) | | |
| Example 5-5 | LiMn_{1.9}Cr_{0.1}O₄ | | | Compound | 0.1 | 74 |
| | | | | (3) | | |
| Example 5-6 | LiMn_{1.9}Fe_{0.1}O₄ | | | Compound | 0.1 | 73 |
| | | | | (3) | | |
| Example 5-7 | LiMn_{1.9}Ni_{0.1}O₄ | | | Compound | 0.1 | 75 |
| | | | | (3) | | |
| Example 5-8 | LiMn_{1.9}Cu_{0.1}O₄ | | | Compound | 0.1 | 73 |
| | | | | (3) | | |

As shown in Table 5, in Example 5-4 using lithium manganate and Examples 5-1 to 5-3 and 5-5 to 5-8 using lithium manganate having a transition metal solid-solved therein, a high capacity retention rate could be realized. In consequence, it was noted that even in the case where any transition metal including aluminum, magnesium, chromium, iron, nickel and copper is used as the element to be solid-solved in lithium manganate, the effect to be brought by the addition of the sulfone compound is obtained.

In Examples 5-1 to 5-3 using at least one member selected from aluminum and manganese as the transition metal to be solid-solved, the capacity retention rate was very high as 90% or more, and an especially conspicuous effect could be obtained.

In the embodiment according to the present application, while examples in which the positive electrode active material according to the present application is used in the nonaqueous electrolyte secondary battery having a cylinder type have been described, it should not be construed that the present application is limited thereto. The positive electrode active material according to the present application can also be used for batteries having other shape such as rectangular batteries and thin-shaped batteries.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A nonaqueous electrolyte battery comprising:
a positive electrode containing a positive electrode active material composed of a lithium complex oxide;
a negative electrode; and
a nonaqueous electrolyte containing a nonaqueous solvent, an electrolyte salt and at least one additive selected from the group consisting of a sulfone compound (1) represented by the following general formula (1) and a sulfone compound (2) represented by the following general formula (2) 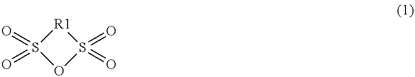
wherein R1 represents CₘH₂ₘ₋ₙXₙ; X represents a halogen; m represents an integer of 2 or more and not more than 4; and n represents an integer of 0 or more and not more than 2m, and 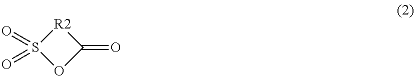
wherein R2 represents CⱼH₂ⱼ₋ₖXₖ; X represents a halogen; j represents an integer of 2 or more and not more than 4; and k represents an integer of 0 or more and not more than 2j.

2. The nonaqueous electrolyte battery according to claim 1, wherein
the sulfone compound (1) represented by the general formula (1) is a sulfone compound (3) represented by the following formula (3)

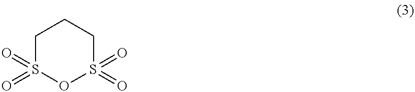

3. The nonaqueous electrolyte battery according to claim 1, wherein
an amount of the additive is 0.03% by mass or more and not more than 5.0% by mass relative to the nonaqueous electrolyte.

4. The nonaqueous electrolyte battery according to claim 1, wherein
the positive electrode active material is composed of a lithium complex oxide having an average composition represented by the following chemical formula (1) or a mixture of a lithium complex oxide having an average composition represented by the following chemical formula (1) and a lithium complex oxide having an average composition represented by the following chemical formula (2)
Li₁₊ₓMn_{2-y}M1_{y}O₄ Chemical formula (1)
wherein
0≦x≦0.15; 0≦y≦0.3; and M1 represents at least one member of elements selected from the group consisting of nickel (Ni), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W), and
LiₐNi_{1-b}M2_{b}O₂ Chemical formula (2)
wherein
0.05≦a≦1.2; 0≦b≦0.5; and M2 represents at least one member of elements selected from the group consisting of iron (Fe), cobalt (Co), manganese (Mn), copper (Cu), zinc (Zn), aluminum (Al), boron (B), gallium (Ga) and magnesium (Mg).

5. The nonaqueous electrolyte battery according to claim 4, wherein the positive electrode active material has a specific surface area, as measured by the BET method using a nitrogen gas, of from 0.05 m²/g or more and not more than 2.0 m²/g.
